(19) United States
(12) Patent Application Publication
(10) Pub. No.: US 2025/0148533 A1
(43) Pub. Date: May 8, 2025

(54) INFORMATION PROCESSING DEVICE, INFORMATION PROCESSING METHOD, RECORDING MEDIUM, AND INFORMATION PROCESSING SYSTEM

(71) Applicant: TOWING, INC., Nagoya-shi (JP)

(72) Inventors: Shunsuke Kimura, Nagoya-shi (JP); Ryoya Nishida, Nagoya-shi (JP); Kohei Nishida, Nagoya-shi (JP)

(21) Appl. No.: 19/013,236

(22) Filed: Jan. 8, 2025

Related U.S. Application Data
(63) Continuation of application No. PCT/JP2023/015592, filed on Apr. 19, 2023.

(30) Foreign Application Priority Data
Jul. 8, 2022 (JP) 2022-110824

(51) Int. Cl. G06Q 40/04

(52) U.S. Cl. CPC G06Q 40/04

(57) ABSTRACT

A demand amount acquisition unit acquires a demand level for carbon credits. A method assignment unit: references a method database in which a plurality of creation methods for creating carbon credits and the carbon credit creation ability of each of the plurality of creation methods are stored in association with each other, and a creator database in which one or more carbon credit creators and the creation methods that each creator is capable of implementing are stored in association with each other; and assigns, within a range that each of the one or more creators can implement, one or more creation methods required to create carbon credits corresponding to the demand level.

### CROSS-REFERENCE TO RELATED APPLICATIONS

The present application is a continuation application of International Application number PCT/JP2023/015592, filed on Apr. 19, 2023, which claims priority under 35 U.S.C § 119(a) to Japanese Patent Application No. 2022-110824, filed on Jul. 8, 2022, contents of which are incorporated herein by reference in their entirety.

### BACKGROUND OF THE INVENTION

The present disclosure relates to an information processing apparatus, an information processing method, a recording medium, and an information processing system.

In recent years, alongside efforts to reduce emissions of greenhouse gases such as carbon dioxide and methane, which are released through various human activities, a concept of “carbon offsetting” has gained traction, which involves compensating for unavoidable greenhouse gas emissions by investing in activities aimed at reducing greenhouse gas emissions. In this context, companies and other entities are engaging in efforts to compensate for greenhouse gas emissions that are difficult to reduce through their own activities by purchasing “carbon credits” representing the reduction or absorption of greenhouse gas emissions achieved by other organizations or at other locations.

As a technology related to the aforementioned efforts, for example, Japanese Unexamined Patent Application Publication No. 2014-139703 discloses a technique for calculating how much methane emissions from rice paddies can be reduced by using methane-suppressing materials in the rice paddies and issuing carbon credits on the basis of the reduction.

With the aforementioned technology, it is possible to quantify the amount of greenhouse gas emissions that can be reduced or absorbed in individual farmlands such as rice paddies. On the other hand, to realize carbon offsetting, there is a need for a system that can meet the demand for carbon credits from entities such as companies by supply from one or more carbon credit creators such as farmland or other sources, and such a system is desired to be built.

### BRIEF SUMMARY OF THE INVENTION

The present disclosure focuses on this point, and an object thereof is to provide a technology for allocating a creation method for creating a demand amount of carbon credits, to a carbon credit creator.

The first aspect of the present disclosure is an information processing apparatus. The apparatus includes a demand amount acquisition part that acquires a demand amount of carbon credit, and a method allocation part that allocates one or more creation methods, required for creating carbon credits corresponding to the demand amount, to the extent that they are feasible for each of one or more carbon credit creators with reference to i) a method database storing a plurality of the creation methods for creating carbon credits and respective carbon credit creation capacities of the plurality of creation methods in association with each other and ii) a creator database storing one or more of the creators and one or more of the creation methods feasible for each of the creators in association with each other.

A second aspect of the present disclosure is an information processing method. The information processing method, executed by a processor, includes the steps of acquiring a demand amount of carbon credit, and allocating one or more creation methods, required for creating carbon credits corresponding to the demand amount, to the extent that they are feasible for each of one or more carbon credit creators with reference to i) a method database storing a plurality of the creation methods for creating carbon credits and respective carbon credit creation capacities of the plurality of creation methods in association with each other and ii) a creator database storing one or more of the creators and one or more of the creation methods feasible for each of the creators in association with each other.

A third aspect of the present disclosure is a non-transitory computer-readable recording medium storing a program. The program causes a computer to realize the functions of acquiring a demand amount of carbon credit, and allocating one or more creation methods, required for creating carbon credits corresponding to the demand amount, to the extent that they are feasible for each of one or more carbon credit creators with reference to i) a method database storing a plurality of the creation methods for creating carbon credits and respective carbon credit creation capacities of the plurality of creation methods in association with each other and ii) a creator database storing one or more of the creators and one or more of the creation methods feasible for each of the creators in association with each other.

In order to provide the program or to update a portion of the program, a computer-readable recording medium on which the program is recorded may be provided and the program may also be transmitted via a communication line.

A fourth aspect of the present disclosure is an information processing system that includes a terminal used by a carbon credit buyer, and an information processing apparatus connected to the terminal via a communication network. The information processing apparatus includes a demand amount acquisition part that acquires a demand amount of carbon credit, and a method allocation part that allocates one or more creation methods, required for creating carbon credits corresponding to the demand amount, to the extent that they are feasible for each of one or more carbon credit creators with reference to i) a method database storing a plurality of the creation methods for creating carbon credits and respective carbon credit creation capacities of the plurality of creation methods in association with each other and ii) a creator database storing one or more of the creators and one or more of the creation methods feasible for each of the creators in association with each other.

It should be noted that any arbitrary combination of the above components, as well as transformations of the present disclosure expressed as methods, devices, systems, computer programs, data structures, or recording media, are also effective embodiments of the present disclosure.

### BRIEF DESCRIPTION OF THE DRAWINGS

FIG. 1 schematically shows an overview of an information processing system according to the embodiment.

FIG. 2 schematically shows a functional configuration of the information processing apparatus according to the embodiment.

FIG. 3 schematically shows an example of a data structure of a method database according to the embodiment.

FIG. 4 schematically shows an example of a data structure of a creator database according to the embodiment.

FIG. 5 schematically shows an example of a data structure of a combination database according to the embodiment.

FIG. 6A schematically shows examples of graphs for explaining creation method combination information.

FIG. 6B schematically shows examples of graphs for explaining creation method combination information.

FIG. 6C schematically shows examples of graphs for explaining creation method combination information.

FIG. 7 is a flowchart illustrating information processing executed by the information processing apparatus according to the embodiment.

FIG. 8 schematically shows a functional configuration of an information processing apparatus according to a third modified example.

FIG. 9 schematically shows a data structure of a creator database according to a fourth modified example.

### DETAILED DESCRIPTION OF THE INVENTION

Hereinafter, the present disclosure will be described through exemplary embodiments of the present disclosure, but the following exemplary embodiments do not limit the disclosure according to the claims, and not all of the combinations of features described in the exemplary embodiments are necessarily essential to the solution means of the disclosure.

### OVERVIEW OF EMBODIMENTS

An information processing apparatus according to the embodiment executes a process of i) selecting a carbon credit creation method in order to create an amount of carbon credits that exceeds a demand amount acquired from a carbon credit buyer (for example, a company) and ii) allocating the selected creation method to a carbon credit creator (sometimes simply referred to as a “creator” below) who implements the method. Here, a “creation method” refers to a method for creating carbon credits, and includes a method for reducing greenhouse gas emissions, a method for sequestrating carbon, and a method for acquiring carbon credits created by others, for example. Further, a “creator” is a party who undertakes the creation of carbon credits by implementing a creation method, such as a farmer.

In many cases, a demand amount for carbon credits from a large organization, such as a company, is greater than a supply of carbon credits that a single creator such as a farmer can create. Therefore, the information processing apparatus according to the embodiment selects one or more carbon credit creation methods and allocates them to one or more creators in order to meet the demand amount for carbon credits.

Here, sizes and aims of individual creators may differ from each other, and the maximum carbon credit creation capacity, a feasible method, a preferred method, and the like may vary for each creator. The information processing apparatus optimizes the creation method to be allocated to each creator, taking into account the creation capacity and requirements of each creator to whom the creation method is allocated. Thus, the information processing apparatus according to the embodiment can optimize allocation of the creation method to the creator in order to meet the demand amount of carbon credits.

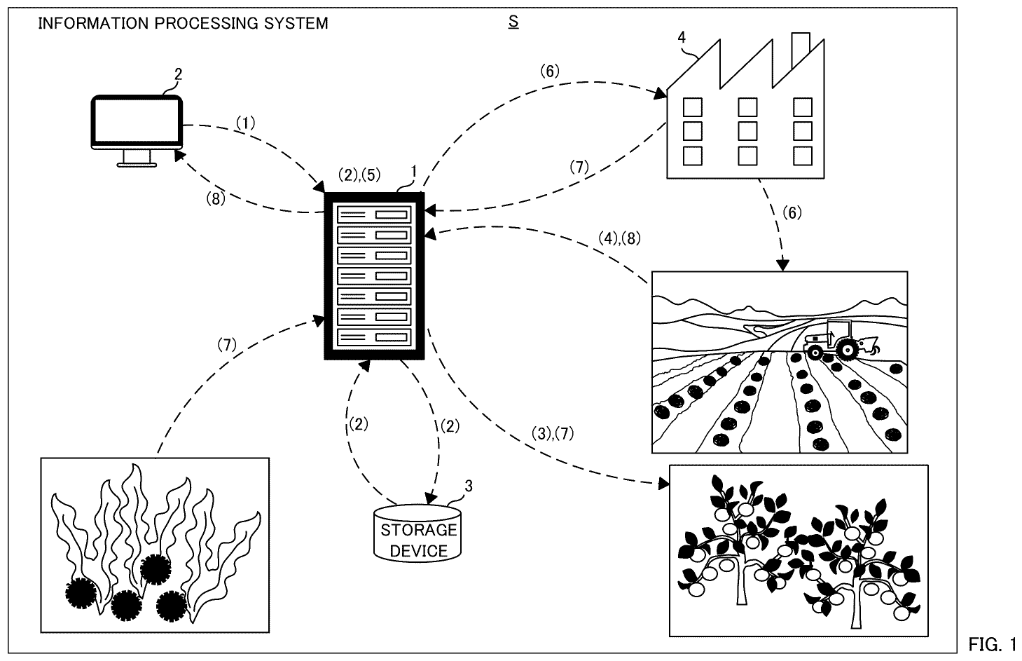

FIG. 1 schematically shows an overview of an information processing system S according to the embodiment. The information processing system S includes an information processing apparatus 1, a buyer terminal 2, and a storage device 3. In the following, an overview of information processing executed in the information processing system S will be described in order of (1) to (8) with reference to FIG. 1, and the numerals correspond to (1) to (8) in FIG. 1.

(1) The information processing apparatus 1 acquires the demand amount of carbon credits from the carbon credit buyer. In the example shown in FIG. 1, the information processing apparatus 1 acquires the demand amount of carbon credits from the buyer terminal 2 used by the carbon credit buyer. Alternatively, or in addition, the information processing apparatus 1 may acquire the demand amount by estimating a future demand amount on the basis of a history of a past demand amount. In this case, the information processing apparatus 1 may predict the demand amount by applying a known estimation algorithm, such as a known Seasonal Autoregressive Integrated Moving Average or Bayesian modeling, to the history of the past demand amount. In addition, the information processing apparatus 1 may acquire a total demand amount obtained by adding up demand amounts from a plurality of buyers, or may use an amount obtained by subtracting a reserved carbon credit from the total demand amount, as the demand amount.

(2) The information processing apparatus 1 allocates one or more creation methods, required for creating carbon credits corresponding to the acquired demand amount, to the extent that they are feasible for each of one or more creators. Here, it is preferable that the creation method broadly includes the following two types. The first type is a method that replaces an existing method, which emits greenhouse gases, with another method that reduces emissions. For example, in greenhouse farming, replacing an old, fuel-inefficient heating system with a new, fuel-efficient heating system reduces the amount of carbon dioxide, a greenhouse gas emitted during the operation of the heating system, thereby creating carbon credits.

The second type is a method that prevents emission of greenhouse gases that would otherwise have been emitted. For example, wood, bamboo, chaff, excrement, and the like, if left untreated, would decompose due to microbial activity and be released into the atmosphere as carbon dioxide. Therefore, by burying these materials as wood charcoal, bamboo charcoal, smoked charcoal from manure, excrement, chaff, and the like (hereinafter referred to as “biochar”) in farmland, carbon that would have been released into the atmosphere as carbon dioxide is stored in the soil to sequestrate carbon, thereby creating carbon credits.

The first type of method reduces the amount of greenhouse gas emissions that have already been released, in other words, it is a method aimed at reducing emissions that are already positive, whereas the second type is a method for limiting future greenhouse gas emissions, essentially a method that reduces the baseline of zero greenhouse gas emissions to a negative value. In this sense, another example of the second type of method is solar power creation with solar panels. This is because carbon credits can be created by suppressing the combustion of fossil fuels that would have occurred to produce the equivalent amount of electricity generated by solar power.

Specifically, each of the aforementioned two types of methods includes a plurality of methods. For example, biochar is offered by a plurality of companies, each having different levels of carbon sequestration capacity and varying upper limits for application. Similarly, when replacing equipment such as a heating system, similar equipment is offered by a plurality of companies, each having different effects on reducing greenhouse gas emissions. Additionally, i) various seedlings (such as tomato seedlings or pepper seedlings) applied with fertilizers also vary in their carbon sequestration capacity and compatibility with fertilizers depending on their type, and ii) different creators have a seedling they are skilled at cultivating, a seedling and equipment they prefer, and the like.

Therefore, the information processing apparatus 1 accesses a method database and a creator database stored in the storage device 3 and solves a combination optimization problem, to allocate a creation method and its extent (for example, the amount of biochar to be buried or the number of seedlings to be planted) to each creator in accordance with the needs of the creator.

(3) The information processing apparatus 1 generates an implementation request for one or more creation methods for one or more carbon credit creators. The information processing apparatus 1 notifies each creator of the generated implementation request using electronic means such as email, a dedicated application, or a web application, or through physical means such as postal mail, and requests implementation of the creation method.

(4) The information processing apparatus 1 acquires, from each of the creators who have been requested for the implementation, the creation method that each of the creators has decided to implement. The creation method and its extent that the creator has decided to implement are referred to as a “decided method.” The information processing apparatus 1 may acquire the decided method i) electronically from an electronic device used by each creator or ii) with an operator of the information processing apparatus 1 entering the decided method notified by post from each creator.

(5) The information processing apparatus 1 calculates, on the basis of the decided method acquired from each creator, the total supply which is the total of carbon credits that can be created by that decided method.

(6) If the total supply is equal to or larger than the demand amount, the information processing apparatus 1 causes a material manufacturer 4 to send the material to be used in the decided method to the creator, to the extent used in the decided method. This enables the creator to execute the creation of carbon credits.

(7) If the total supply is less than the demand amount, the information processing apparatus 1 acquires one or more procurement sources of carbon credits so that an additional supply from the procurement sources is equal to or more than the difference between the demand amount and the total supply. In this context, “procurement” of carbon credits preferably includes the following three types of methods.

The first method is procuring carbon credits by allocating a creation method to the creator who has already decided the decided method, or to a new creator, in the same manner as described above. In this case, the procurement source is a creator such as an aforementioned farmer.

The second method is procuring carbon credits for an action where a reduction in greenhouse gas emissions has already been implemented, but such an action has not been reported to the information processing apparatus 1. For example, if the creator has already implemented a reduction in greenhouse gas emissions by changing equipment or installing solar panels, the information processing apparatus 1 can procure carbon credits corresponding to the reduction. In the case of reducing greenhouse gas emissions by changing equipment, carbon credits are vested in a creator such as a farmer, so the information processing apparatus 1 procures carbon credits by purchasing the carbon credits from the creator such as a farmer. In this case, the procurement source is a creator such as an aforementioned farmer.

In the case of reducing greenhouse gas emissions through the installation of solar panels, carbon credits will be issued to the solar panels. In this case, who owns the carbon credits depends on the sales contract between a panel manufacturer and a creator. If the carbon credits are vested in a creator, the information processing apparatus 1 can procure carbon credits by purchasing the carbon credits from the creator such as a farmer. If the carbon credits are vested in the panel manufacturer, the information processing apparatus 1 procures carbon credits by purchasing the carbon credits from the panel manufacturer. In the case of reducing greenhouse gas emissions through the installation of solar panels, the procurement source is the manufacturer of the equipment that contributes to the reduction of greenhouse gas emissions.

The third method is similar to the first method, but is a method for procuring carbon credits from a person, who is not the creator that the information processing apparatus 1 has requested to implement the creation method, but rather a partner cooperating in the procurement of carbon credits by the information processing apparatus 1. For example, it is known that seaweed growing near the continental shelf absorbs carbon dioxide through photosynthesis. The information processing apparatus 1 can procure carbon credits by purchasing carbon credits corresponding to “blue carbon,” which is carbon dioxide absorbed by this seaweed or phytoplankton, from a person who is working to increase blue carbon or prevent a reduction of blue carbon.

(8) In the case where the decided method involves a product produced in a primary industry (hereinafter simply referred to as a “product”) including an agricultural product such as grains and fruits, a livestock product such as cattle and pigs, and a marine product such as fish and seaweed, the carbon credit buyer may wish to purchase such a product. In this case, the information processing apparatus 1 acquires designation of the product to purchase from the buyer. The information processing apparatus 1 manages tasks of collecting the product from the creator and transporting the collected product to the buyer. As a result, the carbon credit buyer can purchase the product together with carbon credits. In the case where the carbon credit buyer is a company or the like, the purchased product can be consumed in the company's cafeteria, or sold or distributed to employees as a part of welfare benefits.

In this manner, the information processing apparatus 1 according to the embodiment can allocate the creation method for creating the demand amount of carbon credits, to the creator.

### <Function Configuration of Information Processing Apparatus According to Embodiment>

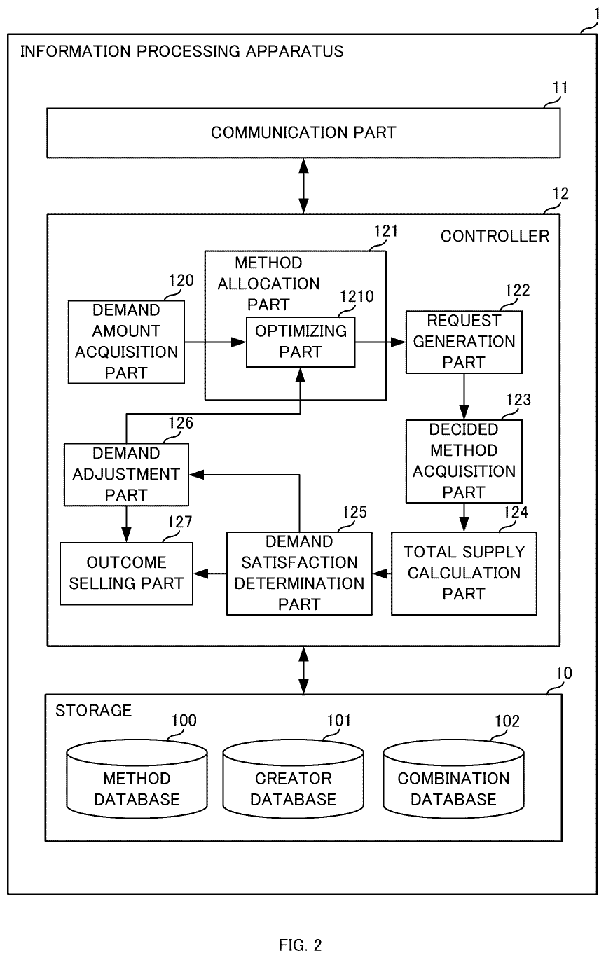

FIG. 2 schematically shows a functional configuration of the information processing apparatus 1 according to the embodiment. The information processing apparatus 1 includes a storage 10, a communication part 11, and a controller 12. In FIG. 2, arrows indicate main data flows, and there may be data flows not shown in FIG. 2. In FIG. 2, each functional block shows a configuration of a functional unit rather than a configuration of a hardware (device) unit. Therefore, the functional blocks shown in FIG. 2 may be implemented in a single device or may be implemented separately in a plurality of devices. Data may be exchanged between the functional blocks via any means such as a data bus, a network, or a portable storage medium.

The storage 10 includes i) a Read Only Memory (ROM) that stores a Basic Input Output System (BIOS) and the like of a computer that realizes the information processing apparatus 1, ii) a Random Access Memory (RAM) that is a work area of the information processing apparatus 1, and iii) a mass storage device such as a Hard Disk Drive (HDD) or a Solid State Drive (SSD) that stores an Operating System (OS), and an application program, and various kinds of information to be referred to when the application program is executed. As shown in FIG. 2, the storage 10 stores a method database 100, a creator database 101, and a combination database 102.

The communication part 11 is a communication interface for the information processing apparatus 1 to exchange data with an external device, and can be realized by using a known communication module such as a known Wi-Fi (registered trademark) module or a Local Area Network (LAN). In the following, the description of the communication part 11 may be omitted on the assumption that each part constituting the information processing apparatus 1 exchanges data with an external device via the communication part 11.

The controller 12 is a processor such as a Central Processing Unit (CPU) or a Graphics Processing Unit (GPU) of the information processing apparatus 1, and functions as a demand amount acquisition part 120, a method allocation part 121, a request generation part 122, a decided method acquisition part 123, a total supply calculation part 124, a demand satisfaction determination part 125, a demand adjustment part 126, and an outcome selling part 127, by executing the program stored in the storage 10.

It should be noted that FIG. 2 shows an example in which the information processing apparatus 1 is configured as a single apparatus. However, the information processing apparatus 1 may be realized by a calculation resource such as a plurality of processors or memories as in a cloud computing system, for example. In this case, each unit constituting the controller 12 is realized by at least any of a plurality of different processors executing the program.

The demand amount acquisition part 120 acquires the demand amount of carbon credits of the carbon credit buyer. The method allocation part 121 allocates one or more creation methods, required for creating carbon credits corresponding to the demand amount acquired by the demand amount acquisition part 120, to the extent that they are feasible for each of one or more creators.

Specifically, the method allocation part 121 acquires candidates of creation methods to be allocated to the respective creators by referring to a method database that stores i) a plurality of creation methods for creating carbon credits and ii) respective carbon credit creation capacities of the plurality of creation methods in association with each other. Subsequently, the method allocation part 121 allocates one or more creation methods to one or more creators by solving an optimization problem with the creation method feasible for each creator as a constraint with reference to a creator database that stores one or more creators and creation methods feasible for each of the creators in association with each other. As a result, the information processing apparatus 1 can allocate the creation method for creating the demand amount of carbon credits, to the creator.

Here, each creator does not necessarily accept the implementation of the creation method allocated to each creator by the information processing apparatus 1. Therefore, the request generation part 122 generates an implementation request for one or more creation methods to one or more creators. Upon receiving the implementation request, the creator decides whether or not to implement the requested creation method, and if so, whether to implement all of the requested creation method, implement only part of it, or modify a portion of it and then perform implementation.

The decided method acquisition part 123 acquires one or more decided methods that are one or more creation methods and their extent, and that one or more creators have decided to implement. As described above, the decided method that the creator has decided to implement may be different from the creation method and its extent of the implementation request generated by the request generation part 122. Therefore, the total supply calculation part 124 calculates, on the basis of one or more creation methods, the total supply which is the total of carbon credits that can be created by those decided methods.

Specifically, the total supply calculation part 124 first calculates the reduction of greenhouse gases due to the introduction of one or more decided methods in reference gas terms, a reference gas is being a type of greenhouse gas such as carbon dioxide. In the following explanation, the reference gas is assumed to be carbon dioxide, but the reference gas may be something other than carbon dioxide. For example, the reference gas may be other greenhouse gases such as methane gas, chlorofluorocarbon gas, and carbon monoxide, whichever is predetermined. Here, it is assumed that the decided method is burying a predetermined amount of biochar in farmland. At this time, the carbon sequestration capacity can be calculated by multiplying the carbon storage amount per unit weight of biochar by a predetermined amount, which is then converted into carbon dioxide to calculate the reduction of greenhouse gases.

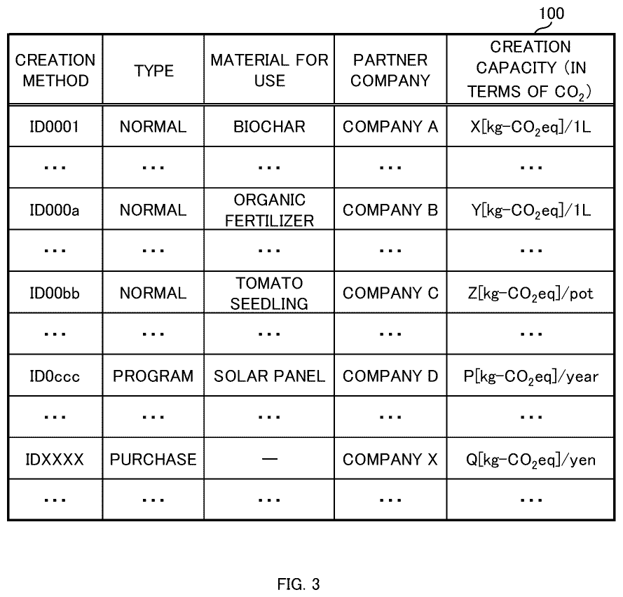

FIG. 3 schematically shows an example of a data structure of a method database 100 according to the embodiment. As shown in FIG. 3, the method database 100 assigns an identifier to each creation method for managing the creation method. In the example of the method database 100 shown in FIG. 3, the creation method with identifier ID0001 utilizes biochar provided by a company A, and its carbon dioxide sequestration capacity is X kilograms per liter. Since carbon credits created using biochar are vested in a creator who purchased the biochar, the type of creation method is “normal.”

In the method database 100 shown in FIG. 3, the creation method with identifier ID0ccc utilizes solar panels. Since carbon credits created using solar panels are vested in a solar panel manufacturer, the type of creation method is “program.” Further, since the creation method with identifier IDXXXX creates carbon credits by purchasing carbon credits from a company X, which is a partner, the type of creation method is “purchase.” The total supply calculation part 124 can calculate the reduction due to the introduction of one or more decided methods in carbon dioxide terms, with references to the method database 100.

Although not shown in the method database 100 shown in FIG. 3, another example of the creation method includes a method that contributes to the creation of carbon credits as a result of reducing greenhouse gas emissions through switching from a conventional farming method that utilizes chemical fertilizers to organic fertilizers. For example, by replacing the greenhouse gases generated during the synthesis process of chemical fertilizers (such as greenhouse gases related to mining and transporting phosphate rock) with domestically produced organic fertilizers, the greenhouse gases associated with the use of chemical fertilizers, including greenhouse gases related to mining and transportation from overseas, can be reduced, thereby creating carbon credits.

Next, the total supply calculation part 124 i) calculates the greenhouse gas emissions required for introducing the decided method and ii) calculates the emissions in carbon dioxide emission terms. In the case where the decided method involves burying a specified amount of biochar in farmland, it is necessary to transport the biochar from a manufacturer's factory to the farmland. At this time, if a vehicle powered by an internal combustion engine is used for transportation, greenhouse gases are emitted as exhaust gas from the internal combustion engine during transportation. If a vehicle powered by electricity is used for transportation, greenhouse gases are generated when generating that electricity. The total supply calculation part 124 can more accurately calculate the greenhouse gas emissions at the time of introducing the decided method by calculating the greenhouse gas emissions according to the power of the vehicle used for transportation.

If the reduction of greenhouse gases achieved by introducing one or more decided methods exceeds the greenhouse gas emissions required for introducing the decided methods, the difference between them is the net reduction of greenhouse gases resulting from the introduction of the decided methods. Therefore, the total supply calculation part 124 calculates the aforementioned total supply by subtracting a) the greenhouse gas emissions required for introducing the decided method, in carbon dioxide emission terms, from b) the reduction of greenhouse gases due to the introduction of one or more decided methods, in carbon dioxide terms.

This enables the information processing apparatus 1 to estimate the total of carbon credits that can be created by the decided method.

Since the method allocation part 121 allocates the creation method to the creator in order to create the demand amount of carbon credits, if all the creators implement the creation method requested by the request generation part 122, the total supply of the carbon credit will meet the demand amount. However, it is possible that the decided method may differ from the creation method included in the implementation request, or their extent may be reduced. Therefore, the demand satisfaction determination part 125 determines a size relationship between the total supply calculated by the total supply calculation part 124 and the demand amount acquired by the demand amount acquisition part 120.

In the case where the total supply is less than the demand amount, the demand adjustment part 126 acquires one or more procurement sources of carbon credits so that an additional supply from the procurement sources is equal to or more than the difference between the demand amount and the total supply. The procurement source of carbon credits is the aforementioned creator such as the farmer, the manufacturer of the equipment, or the partner. The information processing apparatus 1 can ensure the creation of carbon credits that meets the demand amount by repeatedly i) calculating the total supply, ii) comparing the total supply with the demand amount, and iii) acquiring a procurement source, until the total supply exceeds the demand amount.

### (Allocation of Creation Method)

In the following, allocation of the creation method by the method allocation part 121 will be described in more detail.

The plurality of creation methods include a creation method that uses a seedling of a product as a material, such as a tomato seedling. These creation methods are those involving a product as an outcome. If the demand amount acquisition part 120 further acquires designation of a product to purchase in addition to the demand amount of carbon credits, the method allocation part 121 preferentially allocates these creation methods so as to include the creation method involving production of the product designated to be purchased.

The outcome selling part 127 sells carbon credits created by the creator, to the buyer. In addition, the outcome selling part 127 receives, from a potential purchaser, a request to purchase at least a portion of an outcome resulting from the creation method that involves a product as an outcome, and sells the product to the potential purchaser after the product is harvested. Accordingly, the buyer can purchase a product simultaneously with carbon credits, by the buyer becoming the potential purchaser. In addition, a producer of the product, who is also a creator, can easily plan their production because a purchaser of products is determined at the time production begins.

As mentioned above, a producer of a product, who is a creator, each specialize in different types of products. Furthermore, each product producer, as a creator, has a different stance regarding the creation of carbon credits associated with production of a product. For example, while some creators prioritize increasing the yield of their products over creating carbon credits, others focus on securing a certain amount of carbon credits first and, within that, aim to maximize the harvest yield of their products.

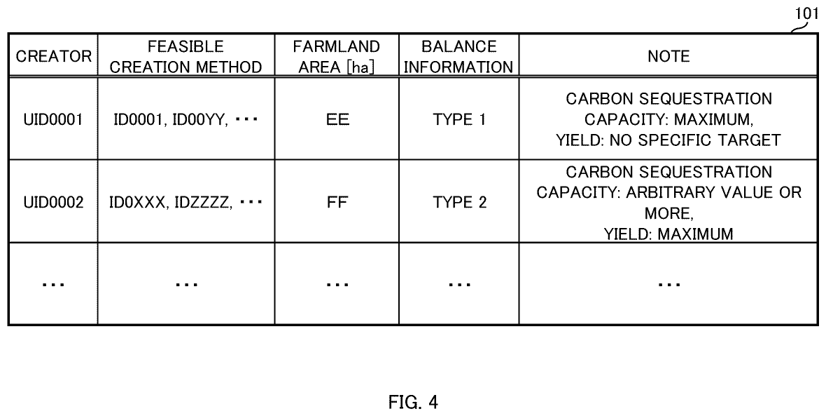

FIG. 4 schematically shows an example of a data structure of the creator database 101 according to the embodiment. As shown in FIG. 4, the creator database 101 manages creators by assigning identifiers to each creator, and stores balance information for each creator to specify the balance between the product yield based on the creation method involving production of the product and the carbon credit creation capacity.

In the example of the creator database 101 shown in FIG. 4, the creator with identifier UID0001 can implement at least the creation methods indicated by identifiers ID0001 and ID00YY, and whose balance information is “type 1.” The type 1 balance information indicates that the priority is to maximize the carbon sequestration capacity (that is, the amount of carbon credits created), while the yield of the product is set without a specific target. Similarly, the creator with identifier UID0002 can implement at least the creation methods indicated by identifiers ID0XXX and IDZZZZ, and whose balance information is “type 2”. The type 2 balance information indicates maximizing yield of product while carbon sequestration capacity is set to be an arbitrary value or more.

These pieces of balance information can be considered as conditions that the method allocation part 121 should take into account when allocating a creation method to each creator. Therefore, the method allocation part 121 includes an optimization part 1210 that allocates one or more creation methods required for creating carbon credits corresponding to the demand amount to the creator, by optimizing an objective function incorporating the balance information as a constraint.

Here, j is used as an indicator for a creator, k is used as an indicator for a creation method that uses farmland, and 1 is used as an indicator for a creation method that does not use farmland and is not depending on farmland. The j-th creator shall be described as a creator j, the k-th creation method that uses farmland shall be described as a creation method k, and the 1-th creation method that does not use farmland shall be described as a creation method 1. Further, the amount of application per unit area when the creator j implements the creation method k is denoted by a^{j}ₖ, and the area of farmland used by the creator j for the creation method k is denoted by h^{j}ₖ.

The creation method that does not use farmland includes methods such as replacing a heating system used by the creator j with a more fuel-efficient system, or replacing agricultural machinery powered by internal combustion engines with electrically driven machinery, and the carbon sequestration capacities for these creation methods are denoted by b^{j}ₖ.

If the creation method k involves a vegetable seedling, the carbon sequestration capacity per unit area r^{j}ₖ changes by changing the amount of application per unit area (density of seedlings to be planted on farmland). Further, if the creation method k involves biochar, the carbon sequestration capacity r^{j}ₖ changes depending on the amount of application per unit area (amount of biochar to be buried per unit area in farmland). As described above, even with the same creation method k, the amount of application per unit area a^{j}ₖ may differ depending on the creator j, and therefore the carbon sequestration capacity per unit area r^{j}ₖ can also differ. r^{j}ₖ is expressed as a function of a^{j}ₖ, which is different for each creation method k. If the function is fₖ, r^{j}ₖ can be expressed by the following Equation (1) using a^{j}ₖ.

$$\begin{matrix}[ Equation 1 ] & \\ {r}_{k}^{j} = {f}_{k} ( {a}_{k}^{j} ) & ( 1 )\end{matrix}$$

In general, when the amount of application per unit area a^{j}ₖ of the creation method k increases, the carbon sequestration capacity per unit area r^{j}ₖ also increases, so that fₖ is a monotonically increasing function.

The area of farmland h^{j}ₖ used by the creator j for the creation method k is determined by the creator j in advance and is registered in the creator database 101 in advance, although not shown in FIG. 4. In this sense, h^{j}ₖ is not a target of optimization by the optimization part 1210, and can be regarded as a constant. At this time, a total of carbon credits C created by all the creators is expressed by the following Equation (2).

$$\begin{matrix}[ Equation 2 ] & \\ C = {\sum }_{j} ( {\sum }_{k} {r}_{k}^{j} {h}_{k}^{j} + {\sum }_{l} {b}_{l}^{j} ) = {\sum }_{j} ( {\sum }_{k} {f}_{k} ( {a}_{k}^{j} ) {h}_{k}^{j} + {\sum }_{l} {b}_{l}^{j} ) & ( 2 )\end{matrix}$$

The yield per unit area of the creation method k implemented by the creator j is denoted by q^{j}ₖ. The yield per unit area q^{j}ₖ of the creation method k depends on the amount of application per unit area a^{j}ₖ of the creation method k implemented by the creator j. For example, the yield increases by increasing the planting density of seedlings on farmland, however, if the density increases too much, it may negatively affect the growth of the seedlings, potentially resulting in a decrease in the yield. Assuming that a function expressing the relationship between the yield q^{j}ₖ and the amount of application a^{j}ₖ is gₖ, q^{j}ₖ can be expressed by the following Equation (3) using a^{j}ₖ. It should be noted that it is sufficient to experimentally determine the yield q^{j}ₖ by implementing the creation method k while varying the application rate per unit area a^{j}ₖ, and then determine a specific form gₖ on the basis of the application rate a^{j}ₖ and the yield q^{j}ₖ.

$$\begin{matrix}[ Equation 3 ] & \\ {a}_{k}^{j} = {g}_{k} ( {a}_{k}^{j} ) & ( 3 )\end{matrix}$$

At this time, the yield of product P^{j}ₖ obtained by the creator j implementing the creation method k is expressed by the following Equation (4).

$$\begin{matrix}[ Equation 4 ] & \\ {P}_{k}^{j} = {q}_{k}^{j} {h}_{k}^{j} = {g}_{k} ( {a}_{k}^{j} ) {h}_{k}^{j} & ( 4 )\end{matrix}$$

The balance information becomes a constraint related to the yield of product P^{j}ₖ expressed by Equation (4). For example, if the balance information indicates that the creator j aims to maximize the yield of product P^{j}ₖ resulting from creation method k, the optimization part 1210 sets maximizing the yield P^{j}ₖ as a constraint. On the other hand, if the creator j does not set a specific target on the yield of product P^{j}ₖ resulting from the creation method k, the optimization part 1210 may determine a^{j}ₖ without providing any constraints for the yield P^{j}ₖ.

Here, there may be a minimum yield (for example, average yield per item or per unit area) that the creator j wants to achieve with respect to the creation method k. In such a case, if the yield target of the creation method k by the creator j is P_{cons}, the following Equation (5) is a constraint of a^{j}ₖ relating to the yield.

$$\begin{matrix}[ Equation 5 ] & \\ {P}_{k}^{j} = {g}_{k} ( {a}_{k}^{j} ) {h}_{k}^{j} \geq {P}_{cons} & ( 5 )\end{matrix}$$

In Equation (2), the term Σ₁b^{j}₁ is determined once the creator j and the creation method 1 are fixed. Additionally, h^{j}ₖ is determined in advance by the creator j. The carbon credit corresponding to the demand amount acquired by the demand amount acquisition part 120 is assumed to be C_{demand}. At this time, the optimization part 1210, using a known optimization method such as linear programming, determines a^{j}ₖ (amount of application per unit area of the creation method k implemented by the creator j) so that C expressed by Equation (2) satisfies C≥C_{demand} under various constraints based on the balance information such as the predetermined h^{j}ₖ and Equation (5).

This allows the information processing apparatus 1 to reflect a stance of each creator towards the carbon credit creation in the allocation of creation methods to be requested to each creator.

The above description assumes that each creation method can be independently implemented. For example, in the case of a single creator, the creation method of cultivating tomatoes and the creation method of replacing a heating system can be implemented simultaneously without interfering with each other. On the other hand, if two different creation methods are used in combination, there is a combination of creation methods in which the methods influence each other.

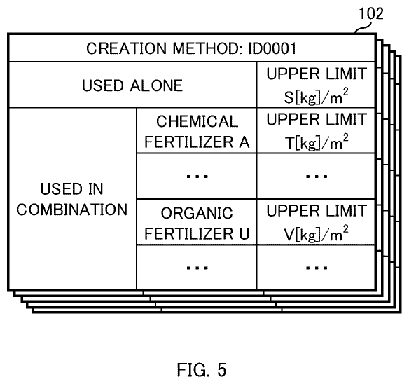

FIG. 5 schematically shows an example of a data structure of the combination database 102 according to the embodiment. The combination database 102 stores creation method combination information indicating conditions to be imposed when different creation methods are used in combination.

As shown in FIG. 5, the combination database 102 stores, for each of a plurality of creation methods, i) an upper limit of the amount of use when the creation method is used alone and ii) an upper limit of the amount of use when the creation method is used in combination with another creation method that exerts an effect when used in combination. FIG. 5 exemplifies the creation method combination information regarding the creation method with identifier ID0001 (biochar from company A).

Biochar has a property of making the soil more alkaline when buried in the ground. On the other hand, it is assumed that a chemical fertilizer A tends to make the soil more acidic when used. Therefore, if biochar and the chemical fertilizer A are used in combination, the effect of biochar can be neutralized by the chemical fertilizer A, resulting in a greater amount of biochar that can be used than when biochar is used alone. That is, in FIG. 5, the upper limit of T [kg]/square meter for use of biochar in combination with the chemical fertilizer A is greater as a value than the upper limit of S [kg]/square meter for use of biochar alone.

On the other hand, an organic fertilizer U containing lime made of, for example, an oyster shell or the like has a property of making the soil more alkaline when used. For this reason, if biochar and the organic fertilizer U are used together, the upper limit for the amount of biochar used is lower than when biochar is used alone, in order to prevent the soil from becoming too alkaline. That is, in FIG. 5, V [kg]/square meter is smaller as a value than S [kg]/square meter.

Although not shown in FIG. 5, the combination database 102 also stores a product as a creation method and agricultural chemicals available for the product as creation method combination information. When allocating the cultivation of a product with limited agricultural chemicals available as a creation method, it is preferable that the information processing apparatus 1 can also suggest agricultural chemicals suitable for that product to the creator. Furthermore, as the acceptable range of soil acidity varies depending on a product grown in farmland, the biochar and fertilizer used in combination may be allocated so that the soil pH is maintained within the acceptable range for the type of product allocated as a creation method. In addition, “agricultural chemicals” are primarily intended for weed control and protecting crops from pests. Therefore, for example, weeding and insect control by birds such as ducks instead of agricultural chemicals used on rice can also help to reduce the greenhouse gas emissions associated with the production of agricultural chemicals and contribute to the creation of carbon credits.

Therefore, the optimization part 1210 allocates one or more creation methods required to create carbon credits equivalent to the demand amount to the creator, by optimizing an objective function incorporating the creation method combination information as a constraint.

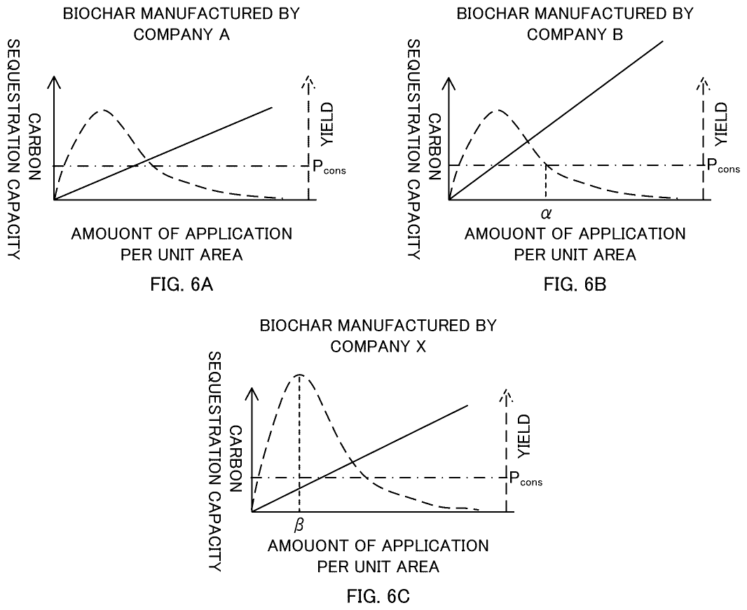

FIGS. 6A to 6C schematically show examples of graphs for explaining the creation method combination information. The graphs shown in FIGS. 6A to 6C are examples, and although not shown in figures, the combination database 102 stores data on the effect of various combinations of creation methods when they are used together.

FIG. 6A is a graph showing i) a relationship between the amount of application of biochar and the carbon sequestration capacity, and ii) the amount of application of the biochar and the yield of product, when the creation method k involving a product as an outcome is used in combination with the biochar from the company A. In FIG. 6A, the horizontal axis represents the amount of application of biochar per unit area, the vertical solid-line axis and the solid-line graph represent the carbon sequestration capacity, and the vertical broken-line axis and the broken-line graph represent the yield. FIG. 6A shows that the carbon sequestration capacity is proportional to the amount of application per unit area. On the other hand, it is shown that the yield increases as the amount of application per unit area increases, but eventually reaches a plateau and ultimately begins to decline.

FIG. 6B is a graph showing i) a relationship between the amount of application of the biochar from a company B and the carbon sequestration capacity, and ii) the amount of application of the biochar and the yield of product. Similarly, FIG. 6C is a graph showing i) a relationship between the amount of application of the biochar from a company X and the carbon sequestration capacity, and ii) the amount of application of the biochar and the yield of product.

Comparing FIG. 6A and FIG. 6B, the change in the yield of product in relation to the amount of application of biochar is almost the same. On the other hand, it can be seen that the company B biochar shows higher carbon sequestration capacity than the company A biochar, even at the same amount of application. Further, comparing FIG. 6A and FIG. 6C, it can be seen that the company X biochar has i) a slightly higher carbon sequestration capacity than the company A biochar and ii) a higher maximum value of the yield when the biochar is applied.

For example, it is assumed that, for a certain creator j, the balance information regarding the certain creation method k is “the yield is equal to or larger than a predetermined amount P_{cons}, and the carbon sequestration capacity is at a maximum.” In this case, the optimization part 1210 searches for a condition that the carbon sequestration capacity is at a maximum under the constraint shown in Equation (4). The examples shown in FIGS. 6A to 6C show that, when the amount of application per unit area of the biochar from the company B is denoted as a, the carbon sequestration is at a maximum while the yield is equal to or more than the predetermined amount P_{cons}. Therefore, the optimization part 1210 derives a solution for the amount of application per unit area of the biochar from the company B for the creation method k as α.

As another example, it is assumed that, for the certain creator j, the balance information regarding the certain creation method k is “the yield is at a maximum, and there is no specific target for the carbon sequestration capacity.” In this case, the optimization part 1210 searches for a condition that the yield is at a maximum without considering the carbon sequestration capacity as a constraint. The examples shown in FIGS. 6A to 6C show that, when the amount of application per unit area of the biochar from the company X is denoted as β, the yield is at a maximum. Therefore, the optimization part 1210 derives a solution for the amount of application per unit area of the biochar from the company X for the creation method k as β.

As described above, the information processing apparatus 1 can reflect the effect of the combined use of creation methods in the allocation of creation methods.

### <Processing of Information Processing Method Executed by Information Processing Apparatus 1>

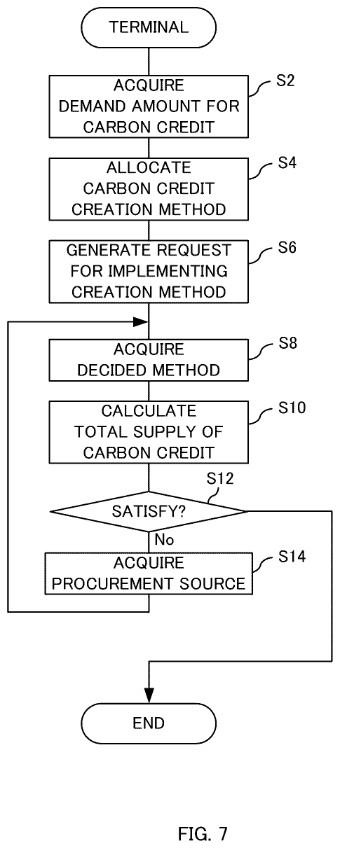

FIG. 7 is a flowchart illustrating information processing executed by the information processing apparatus 1 according to the embodiment. The processing in this flowchart starts when the information processing apparatus 1 is activated, for example.

The demand amount acquisition part 120 acquires the demand amount for the carbon credit of the carbon credit buyer (S2). The method allocation part 121 allocates one or more creation methods, required for creating carbon credits corresponding to the demand amount, to the extent that they are feasible for each of one or more creators (S4).

The request generation part 122 generates a request to implement one or more creation methods for one or more carbon credit creators (S6). The decided method acquisition part 123 acquires one or more decided methods that are one or more creation methods and their extents, and that one or more creators have decided to implement (S8).

The total supply calculation part 124 calculates, on the basis of one or more creation methods, the total supply which is the total of carbon credits that can be created by those decided methods (S10). If the total supply is insufficient for the demand amount of the carbon credits (No in S12), the demand adjustment part 126 acquires one or more procurement sources of carbon credits so that an additional supply from the procurement sources is equal to or more than the difference between the demand amount and the total supply (S14). Thereafter, the information processing apparatus 1 returns to the process of step S8 and repeats the process of step S8 and the process of step S10.

If the total supply satisfies the demand amount of the carbon credits (Yes in S12), the process in this flowchart ends.

### <Effect of Information Processing Apparatus 1 According to Embodiment>

As described above, according to the information processing apparatus 1 of the embodiment, it is possible to allocate the creation method for creating the demand amount of carbon credits, to the creator.

The present disclosure is explained on the basis of the exemplary embodiments. The technical scope of the present disclosure is not limited to the scope explained in the above embodiments and it is possible to make various changes and modifications within the scope of the disclosure. For example, all or part of the apparatus can be configured with any unit which is functionally or physically dispersed or integrated. Further, new exemplary embodiments generated by arbitrary combinations of them are included in the exemplary embodiments of the present disclosure. Further, effects of the new exemplary embodiments brought by the combinations also have the effects of the original exemplary embodiments.

### First Modified Example

In the above description, the outcome selling part 127 of the information processing apparatus 1 receives a request for purchasing a product produced by the creator, from a potential purchaser. In addition, the outcome selling part 127 may also receive a request for purchasing a product produced by a partner, from a potential purchaser.

For example, some partners who are working to increase blue carbon or prevent a reduction of blue carbon are protecting seaweed by capturing sea urchins and other organisms that devour the seaweed that grows near the continental shelf, while at the same time farming and selling the captured organisms for food. The outcome selling part 127 receives a purchase request from a potential purchaser of organisms farmed by the partner for food, thereby providing the potential purchaser with the product produced by the partner.

### Second Modified Example

In the above description, the method allocation part 121 refers to the creator database 101 to allocate the creation method to each creator in consideration of the balance information of each creator. In addition to this, the method allocation part 121 may allocate the creation methods with a constraint that the risk for each creator when applying the creation method is lowered. Moreover, the method allocation part 121 may allocate a creation method with a constraint that production volume of the production produced by each creator approaches the target sales volume, taking into account the target sales volume of the production held by each of the creators. In this case, the creator database 101 may store the risk when applying the creation method and the target sales volume, associated with each creator.

### Third Modified Example

In the above description, the total supply calculation part 124 calculates the total supply on the basis of one or more decided methods. However, not all creators will implement all of the decided methods that have been decided, and the methods themselves or their extent may differ for some reason.

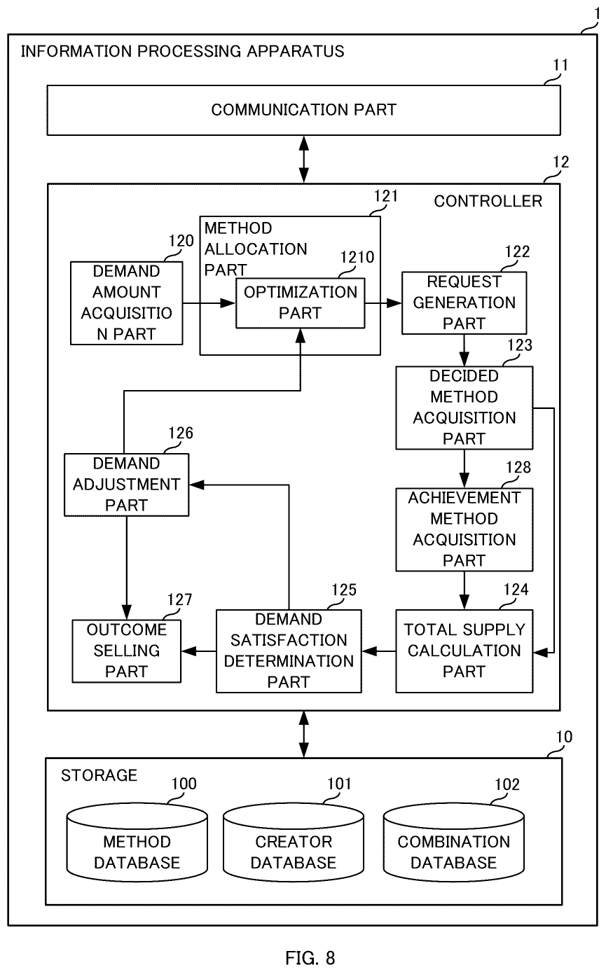

FIG. 8 schematically shows a functional configuration of the information processing apparatus 1 according to a third modified example. The information processing apparatus 1 according to the third modified example is different from the information processing apparatus 1 according to the embodiment shown in FIG. 2 in that it includes an achievement acquisition part 128, but is otherwise the same. In the following, parts that are common to the information processing apparatus 1 according to the third modified example and the information processing apparatus 1 according to the embodiment will be omitted or simplified as appropriate.

The achievement acquisition part 128 acquires an actually implemented method as an achieved method from each creator who has acquired the decided method. Specifically, the achievement acquisition part 128 acquires the achieved method from the creator by electronic means, such as email, dedicated applications, web applications, or by mailing a dedicated application form filled out by the creator.

The total supply calculation part 124 calculates the total supply by subtracting a) the amount of greenhouse gas emissions required for introducing the achieved method, in carbon dioxide emission terms, from b) the reduction amount of greenhouse gases by introducing each of the achieved methods acquired by the achievement acquisition part 128, in carbon dioxide terms. Through this process, the total supply calculation part 124 can more accurately calculate the total supply on the basis of the achieved method actually implemented by each creator.

### Fourth Modified Example

In the above description, the creator database 101 stores a correspondence between each creator and the creation methods feasible for that creator. Alternatively, the creator database 101 may store each creator and the area of farmland available to that creator, the currently planted crops, and the materials currently in use.

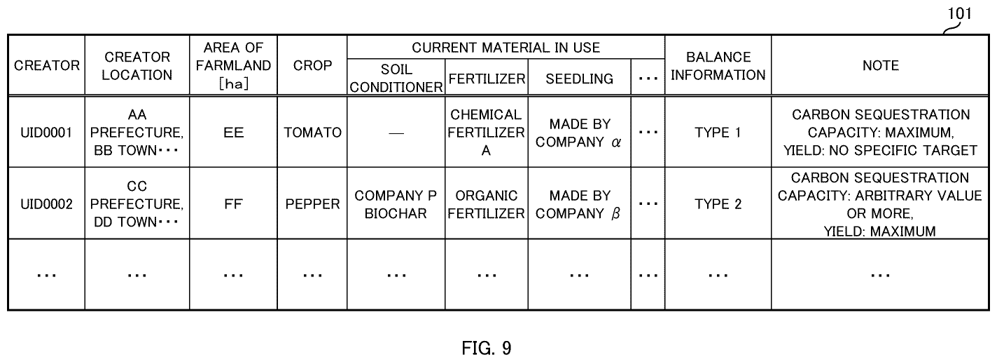

FIG. 9 schematically shows a data structure of the creator database 101 according to a fourth modified example. As shown in FIG. 9, the creator database 101 according to the fourth modified example stores the identifier assigned to each creator along with the creator's location, the area of farmland available to the creator, the currently planted crops, and the materials currently in use. For example, from the example of the creator database 101 shown in FIG. 9, it can be seen that a creator with identifier UID0001 is located in BB town, AA prefecture, has EE [ha] of farmland, currently plants tomatoes, does not use any soil conditioner, uses a chemical fertilizer A, and uses a seedling from a company a.

The method allocation part 121 according to the fourth modified example refers to the creator database 101 to i) determine crops that are feasible to be planted in that region according to the location of each creator, and ii) calculates the feasible planting quantity (for example, the number of seedlings) for each determined crop on the basis of the area of farmland available for each creator. In this manner, the method allocation part 121 can determine the creation method feasible for each creator and its extent even if the creation method feasible for each creator is not recorded in the creator database 101. In addition, the optimization part 1210 can refer to the creator database 101 to reflect the creation methods (for example, soil conditioners, various fertilizers, and the like) already implemented by each creator in the allocation of the creation methods. As a result, the optimization part 1210 can improve the accuracy of allocation of the creation method.

### Fifth Modified Example

In the above description, the total supply calculation part 124 calculates the total supply as a net reduction R(=P−Q), obtained by subtracting a) greenhouse gas emissions Q required for introducing the decided method, in carbon dioxide emission terms from b) a reduction P due to the introduction of one or more decided methods in carbon dioxide terms. Alternatively, the total supply calculation part 124 may use greenhouse gas emissions B before the introduction of the decided method as the baseline, and may have, as the total supply, the value T(=R−B=P−Q−B), which is obtained by subtracting the baseline emissions B from the net reduction R, in carbon dioxide emission terms. In this case, carbon credits are generated only when the greenhouse gas reduction effect resulting from the introduction of the decided method exceeds the amount of greenhouse gases previously emitted. This encourages introduction of decided methods that result in negative greenhouse gas emissions.

### Sixth Modified Example

The method database 100 and the creator database 101 described above may be implemented as separate databases or as a single integrated database. If the method database 100 and the creator database 101 are partially or fully integrated into a single integrated database (not shown in figures) to be implemented, i) some or all of the creation methods included in the database 100 shown in FIG. 3 may be associated with creators capable of implementing those creation methods, and ii) the same details as those in the creator database 101 shown in FIG. 4 may be associated with each creator to form the integrated database.

What is claimed is:

1. An information processing apparatus comprising:
a demand amount acquisition part that acquires a demand amount of carbon credit; and
a method allocation part that allocates one or more creation methods, required for creating carbon credits corresponding to the demand amount, to the extent that they are feasible for each of one or more carbon credit creators with reference to i) a method database storing a plurality of the creation methods for creating carbon credits and respective carbon credit creation capacities of the plurality of creation methods in association with each other and ii) a creator database storing one or more of the creators and one or more of the creation methods feasible for each of the creators in association with each other.

2. The information processing apparatus of claim 1, further comprising:
a request generation part that generates a request to one or more of the carbon credit creators to implement one or more of the creation methods;
a decided method acquisition part that acquires one or more decided methods that are one or more of the creation methods and their extent, and that one or more of the carbon credit creators have decided to implement; and
a total supply calculation part that calculates a total supply that is a total of carbon credits that can be created by the decided methods, on the basis of one or more of the decided methods.

3. The information processing apparatus of claim 2, wherein
the total supply calculation part calculates the total supply by subtracting a) greenhouse gas emissions required for introducing the decided methods, in reference gas emission terms, from b) a reduction amount of greenhouse gas emissions due to the introduction of one or more of the decided methods, in predetermined reference gas emission terms.

4. The information processing apparatus of claim 2, wherein
the total supply calculation part calculates the total supply by subtracting a) greenhouse gas emissions required for introducing the decided methods, in reference gas emission terms, from b) a reduction amount of greenhouse gas emissions due to the introduction of one or more of the decided methods, in predetermined reference gas emission terms, and then further subtracting c) greenhouse gas emissions before introducing one or more of the decided methods, in reference gas emissions terms.

5. The information processing apparatus according to claim 2, further comprising:
a demand satisfaction determination part that determines a size relationship between the total supply calculated by the total supply calculation part and the demand amount acquired by the demand amount acquisition part; and
a demand adjustment part that acquires one or more procurement sources of carbon credits so that an additional supply from the procurement sources is equal to or greater than a difference between the demand amount and the total supply, if the total supply is less than the demand amount.

6. The information processing apparatus according to claim 1, wherein
the plurality of creation methods for creating carbon credits include a creation method involving a product as an outcome,
the demand amount acquisition part further acquires designation of a product to purchase, and
the method allocation part allocates the creation method so as to include a creation method involving production of the product designated for purchasing.

7. The information processing apparatus according to claim 1, wherein
the plurality of creation methods for creating carbon credits include a creation method involving a product as an outcome,
the creator database includes balance information for specifying a balance between a yield of product based on a creation method involving production of the product and a carbon credit creation capacity, and
the method allocation part includes:
an optimization part that allocates one or more of the creation methods required for creating carbon credits corresponding to the demand amount to the creator, by optimizing an objective function incorporating the balance information as a constraint.

8. The information processing apparatus according to claim 1, further comprising:
a combination database that stores creation method combination information indicating a condition to be imposed when different creation methods are used in combination, wherein
the method allocation part includes:
an optimization part that allocates one or more of the creation methods required for creating carbon credits corresponding to the demand amount to the creator, by optimizing an objective function incorporating the creation method combination information as a constraint.

9. The information processing apparatus of claim 6, further comprising:
an outcome selling part that sells at least some of an outcome to a potential purchaser of the outcome resulting from a creation method involving a product as an outcome.

10. An information processing method, executed by a processor, the method comprising the steps of:
acquiring a demand amount of carbon credit; and
allocating one or more creation methods, required for creating carbon credits corresponding to the demand amount, to the extent that they are feasible for each of one or more carbon credit creators with reference to i) a method database storing a plurality of the creation methods for creating carbon credits and respective carbon credit creation capacities of the plurality of creation methods in association with each other and ii) a creator database storing one or more of the creators and one or more of the creation methods feasible for each of the creators in association with each other.

11. A non-transitory computer-readable recording medium storing a program for causing a computer to realize the functions of:
acquiring a demand amount of carbon credit; and
allocating one or more creation methods, required for creating carbon credits corresponding to the demand amount, to the extent that they are feasible for each of one or more carbon credit creators with reference to i) a method database storing a plurality of the creation methods for creating carbon credits and respective carbon credit creation capacities of the plurality of creation methods in association with each other and ii) a creator database storing one or more of the creators and one or more of the creation methods feasible for each of the creators in association with each other.

12. An information processing system comprising:
a terminal used by a carbon credit buyer; and
an information processing apparatus connected to the terminal via a communication network, wherein
the information processing apparatus includes:
a demand amount acquisition part that acquires a demand amount of carbon credit; and
a method allocation part that allocates one or more creation methods, required for creating carbon credits corresponding to the demand amount, to the extent that they are feasible for each of one or more carbon credit creators with reference to i) a method database storing a plurality of the creation methods for creating carbon credits and respective carbon credit creation capacities of the plurality of creation methods in association with each other and ii) a creator database storing one or more of the creators and one or more of the creation methods feasible for each of the creators in association with each other.
